(19) United States
(12) Patent Application Publication
(10) Pub. No.: US 2016/0205969 A1
(43) Pub. Date: Jul. 21, 2016

(54) SOLID DIETARY COMPOSITIONS FOR RUMINANTS AND METHODS OF MAKING AND USING THE SAME

(71) Applicant: BENEMILK OY, Raisio (FI)

(72) Inventors: Feng Wan, Issaquah, WA (US); Ilmo Pellervo Aronen, Hinnerjoki (FI); Merja Birgitta Holma, Raisio (FI); Christopher John Buntel, Singapore (SG); Jayesh Ramesh Bellare, Mumbai (IN); James Edward Nocek, Auburn, NY (US)

(73) Assignee: Benemilk Oy, Raisio (FI)

(21) Appl. No.: 14/908,097

(22) PCT Filed: Jul. 30, 2013
(86) PCT No.: PCT/US2013/052632

§ 371 Date: Jan. 27, 2016

(51) Int. Cl. A23K 20/158; A23K 20/20; A23K 20/174; A23K 50/10; A23K 20/142

(52) U.S. Cl. CPC A23K 20/158; A23K 50/10; A23K 20/142; A23K 20/174; A23K 20/20

(57) ABSTRACT

Solid dietary compositions for ruminants are disclosed, as well as methods for their preparation and use. The compositions may include a fatty acid component and at least one feed ingredient. The fatty acid component may include at least about 90% saturated fatty acid by weight and may be present in the dietary composition in an amount of at least about 30% by weight of the dietary composition. The at least one feed ingredient may be selected from a protein material, an amino acid, an amino acid derivative, a vitamin, a trace element, a mineral, a glucogenic precursor, and an antioxidant. The dietary composition may be a solid in the form of a capsule, a tablet, a pellet, or a granular material.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

A common approach to increasing either or both production and milk fat contents includes adjusting feed, nutrients, elements, vitamins, supplements, and/or the like provided to the ruminant. One such specific method includes feeding the ruminant a total mixed ration (TMR), which is a mix of grain and silage with some protein meals, such as, for example, soya bean meal and canola meal. Additional materials and trace elements, vitamins, extra nutrients, and the like may also be added to the TMR.

However, the current methods and feeds used to increase milk fat content tend to lower milk production, lower protein content, and/or have other detrimental effects on the ruminant. Furthermore, the methods and feeds oftentimes result in other undesired effects, such as increased trans fatty acid levels on the fatty acid profile of the milk fat.

### SUMMARY

In an embodiment, a dietary composition for ruminants may include a fatty acid component and at least one feed material. The fatty acid component may be at least about 90% saturated fatty acid by weight and may be present in the dietary composition in an amount of at least about 30% by weight of the dietary composition. The at least one feed ingredient may be selected from a protein material, a carbohydrate material, an amino acid, an amino acid derivative, a vitamin, a trace element, a mineral, a glucogenic precursor, and an antioxidant. The dietary composition is a solid in the form of a capsule, a tablet, a pellet, or a granular material.

In an embodiment, a method of preparing a dietary composition for ruminants may include combining a fatty acid component and a feed ingredient to form a mixture and processing the mixture into a tablet, a capsule, a pellet, or a granular material. The feed ingredient may include one or more of a protein material, a carbohydrate material, an amino acid, an amino acid derivative, a vitamin, a trace element, a mineral, a glucogenic precursor, and an antioxidant. The fatty acid component may be present in the dietary composition in an amount of at least about 30% by weight of the dietary composition.

In an embodiment, a method of increasing milk fat content in ruminants may include providing a dietary composition to a ruminant for ingestion. The dietary supplement may include a fatty acid component and at least one feed ingredient. The fatty acid component may include less than about 10% unsaturated fatty acid by weight and may be present in the dietary composition in an amount of at least about 30% by weight of the dietary composition. The at least one feed ingredient may be selected from a protein material, a carbohydrate material, an amino acid composition, an amino acid derivative, a vitamin composition, a trace element, a mineral composition, a glucogenic precursor, and an antioxidant. The dietary composition may be a capsule, a tablet, a pellet, or a granular material.

In an embodiment, a dietary composition for ruminants may include a fatty acid component having a palmitic acid composition in an amount of at least about 90% by weight of the fatty acid component. The dietary composition may also include at least one feed ingredient selected from a protein material, a carbohydrate, an amino acid, an amino acid derivative, a vitamin, a trace element, a mineral, a glucogenic precursor, and an antioxidant. The fatty acid component may be present in the dietary composition in an amount of at least about 30% by weight of the dietary composition. The dietary composition is a capsule, a tablet, a pellet, or a granular material.

### BRIEF DESCRIPTION OF THE DRAWINGS

FIG. 1 depicts a flow diagram of a method of preparing a dietary composition for ruminants according to an embodiment.

FIG. 2 depicts a flow diagram of an alternative method of preparing a dietary composition for ruminants according to various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “ruminant” is a class of mammal with a multiple chamber stomach that gives the animal an ability to digest cellulose-based food by softening it within the first chamber (rumen) of the stomach and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

“Silage” refers to a feed that includes chopped green forage, such as, for example, grass, legumes, and field corn. The silage is placed in a structure or a container that is designed to exclude air. The silage is then fermented in the structure or container, thereby retarding spoilage. Silage can have a water content of about 60% to about 80% by weight.

The present disclosure relates generally to dietary compositions such as supplements and the like that can be fed to ruminants for purposes of affecting milk production in the ruminant Particularly, the dietary compositions described herein may be fed to a ruminant to increase the amount of milk produced by the ruminant and/or to increase the fat content of the milk produced by the ruminant, as described in greater detail herein. Specific compositions described herein may be in solid form and may be used as solid boosters for ruminants, including solids in the form of a capsule, a tablet, a pellet, or a granular material.

When a ruminant consumes feed, the fat in the feed is modified by the rumen to provide a milk fat profile that is different from the profile of fat in the feed. All fats which are not completely inert in the rumen may decrease rumen digestibility of the feed material. Milk composition and fat quality can be influenced by the ruminant's diet. For example, oil feeding can have negative effects on both rumen function and milk formation. As a result of the oil feeding, the milk protein concentration is lowered, the fat concentration is decreased, and the proportion of trans fatty acids is increased. These have been connected especially to an increase in the harmful low-density lipoprotein (LDL) cholesterol and to a decrease in the beneficial high-density lipoprotein (HDL) cholesterol in human blood when the milk is consumed. In addition, the properties of the milk fat during industrial milk processing are weakened. A high level of polyunsaturated fatty acids in milk can also cause taste defects and preservation problems. A typical fatty acid composition of milk fat may contain more than 70% saturated fatty acids and total amount of trans fatty acids may vary in the range of 3%-10%. When vegetable oil is added into the feed, the proportion of trans fatty acids may rise to more than 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in rumen can be avoided. However, fatty acid salts have a pungent taste, which can limit their usability in feeds and can result in decreased feed intake. The salts may also impact the pelletizing process of the feed.

Accordingly, the dietary composition described herein allows for the transfer of palmitic acid from the feed via the digestive tract into the blood circulation of a ruminant. This improves the energy efficiency of milk production of the ruminant. When the utilization of energy becomes more efficient, the milk production increases and the concentrations of protein and fat in the milk rise. Especially, the dietary composition enhances fat synthesis in the mammary gland by bringing milk fat components to the cell and therefore the energy consuming synthesis in the mammary gland may not be necessary. Thus, glucose may be more efficiently used for lactose production whereupon milk production increases. The milk protein content rises since there may be no need to produce glucose from amino acids. Thus, the ruminant therefore may not lose as much weight at the beginning of the lactation period.

In the various embodiments described herein, the solid compositions may include at least a fatty acid component and a feed ingredient. The fatty acid component may be primarily saturated fatty acid (such as palmitic acid) and may contain little or no unsaturated trans fatty acid, as described in greater detail herein. The fatty acid component may be about 30% to about 80%, about 30% to about 50%, about 40% to about 60%, and about 60% to about 90% by weight of the composition, and the feed ingredient about 20% to about 70%, about 10% to about 40%, about 50% to about 70% by weight of the composition. In some embodiments, the compositions described herein may be used as a booster or a supplement to other feed.

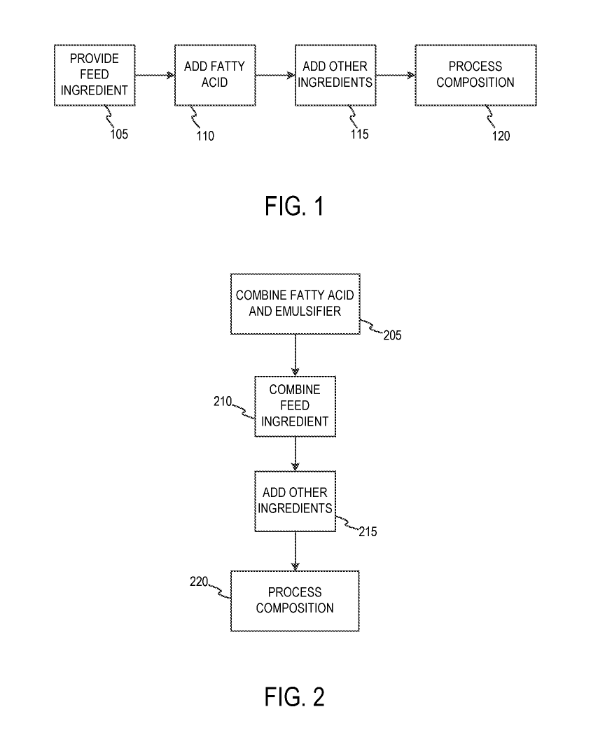

FIG. 1 depicts a flow diagram of a representative method of preparing a dietary composition for consumption by a ruminant. In various embodiments, the dietary composition may be formulated in a manner so that when consumed by the ruminant, the dietary composition maximizes particular qualities in the milk produced by the ruminant, as well as an amount of milk produced by the ruminant, as described in greater detail herein. In particular embodiments, the dietary composition may be substantially a solid dietary composition, including, but not limited to, a capsule, a tablet, a pellet, or a granular material.

In various embodiments, the components described herein with respect to FIG. 1 may generally be combined in any order and/or any combination, and are not limited by the order described herein. In some embodiments, a dietary composition may be prepared by providing 105 a feed ingredient and adding 110 a fatty acid to the feed ingredient. Thus, processes 105 and 110 result in combining the feed ingredient and the fatty acid to obtain the dietary composition.

In various embodiments, one or more other ingredients may be added 115 to the dietary composition. The other ingredients may be added 115 at substantially the same time as processes 105 and 110, may be added subsequent to processes 105 and 110, may be added prior to processes 105 and 110, or may be added during process 120, as described in greater detail herein. Illustrative examples of other ingredients that may be added 115 include a binding agent, a bulking agent, a filler, and the like, or a combination thereof. The binding agent may provide adhesive properties to the dietary composition, particularly so that the dietary composition does not fall apart in various forms such as pellet and tablet forms. Examples of binding agents include polysaccharides, proteins, and the like, or a combination thereof. The bulking agent may generally increase the bulk of the dietary composition without affecting the taste of the dietary composition. Examples of bulking agents may include silicate, kaolin, clay, and/or the like. The filler may generally be used to increase bulk, weight, viscosity, opacity, strength, and/or the like. Examples of filler may include gluten feed, sunflower hulls, distillers grains, guar hulls, wheat middlings, rice hulls, rice bran, oilseed meals, dried blood meal, animal byproduct meal, fish byproduct meal, dried fish solubles, feather meal, poultry byproducts, meat meal, bone meal, dried whey, soy protein concentrate, soy flour, yeast, wheat, oats, grain sorghum, corn feed meal, algae meal, rye, corn, barley, aspirated grain fractions, brewers dried grains, corn flower, corn gluten meal, feeding oat meal, sorghum grain flour, wheat mill run, wheat red dog, hominy feed, wheat flower, wheat bran, wheat germ meal, oat groats, rye middlings, cotyledon fiber, and/or ground grains.

In various embodiments, the dietary composition may be processed 120 to obtain a final product. In some embodiments, processing 120 may include forming the dietary composition into a capsule, a shell, a pellet, a tablet, a granular material, and/or the like. Accordingly, processing 120 may include pressing, molding, extruding, grinding, pelleting, encapsulating, granulating and/or the like. Pressing may include, for example, applying a pressure to an amount of the dietary composition. Molding may include, for example, open molding, compression molding, injection molding, centrifugal molding, or the like. Extruding may include, for example, forming an amount of the dietary composition by forcing the dietary composition through a die having a desired shape and size.

Grinding may be performed by various grinding devices known to those having ordinary skill in the art, such as a hammer mill, a roller mill, a disk mill, or the like. The dietary composition and/or portions thereof may be ground to various sizes, such as particle size (for instance, measured in millimeters), mesh sizes, surface areas, or the like. According to some embodiments, the dietary composition and/or portions thereof may be ground to an average particle size of about 0.05 mm to about 10 mm More particularly, the dietary composition may be ground to produce a granular material having an average particle size of about 0.05 mm, about 0.1 mm, about 0.2 mm, about 0.5 mm, about 1.0 mm, about 2.0 mm, about 3.0 mm, about 4.0 mm, about 5.0 mm, about 6.0 mm, about 7.0 mm, about 8.0 mm, about 9.0 mm, about 10.0 mm, or any value or range between any two of these values. In some embodiments, the dietary composition may be ground so that about 20% to 50% of the ground dietary composition is retained by a mesh having openings with a size of about 10 mm and so that about 70% to about 90% of the ground dietary composition is retained by a mesh having openings with a size of about 1 mm. In some embodiments, the dietary compositions and/or various portions thereof may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

Grinding may provide various benefits, such as improving certain characteristics of the feed ingredient and/or the dietary composition formed therefrom. For instance, even and fine particle size may improve the mixing of different ingredients. According to certain embodiments, grinding may be configured to decrease a particle size of certain components of the dietary composition, for example, to increase the surface area open for enzymes in the gastrointestinal tract, which may improve the digestibility of nutrients, and/or to increase the palatability of the feed.

In some embodiments, the granular material or powder may be used in subsequent processes such as molding, tableting, extrusion, and/or tableting. In some embodiments, processing 120 may include drying the dietary composition. Drying may generally be completed to remove any excess water or other undesired materials, as well as to provide a material that is suitable for encapsulation, pelleting, extrusion, grinding, pressing and/or the like.

“Granular material”, as used herein, refers to a conglomeration of discrete solid, macroscopic particles and is meant to encompass a wide variety of material types, shapes, and sizes. Granular material includes powders as a subset, but also includes groups of larger particles. Granular material may be particularly well-suited for tableting and encapsulation, as well as molding.

In various embodiments, the feed ingredient may be present in the dietary composition in an amount of about 20% to about 70%, about 10% to about 40%, about 50% to about 70% by weight of the dietary composition. In particular embodiments, the feed ingredient may be present in the dietary composition in an amount of about 20% by weight, about 25% by weight, about 30% by weight, about 35% by weight, about 40% by weight, about 45% by weight, about 50% by weight, about 55% by weight, about 60% by weight, about 65% by weight, about 70% by weight, or any value or range between any two of these values.

In various embodiments, the feed ingredient may include a carbohydrate, a protein, an amino acid, an amino acid derivative, a vitamin, a trace element, a mineral, a glucogenic precursor, an antioxidant, and/or the like. The feed ingredient may include various portions generally included in particular amounts that are sufficient to provide beneficial nutritional and dietary needs of the ruminant that is to consume the dietary composition. For example, the feed ingredient may include a carbohydrate portion and a vitamin portion, each in an amount sufficient to provide beneficial nutritional and dietary needs of the ruminant.

The carbohydrate is not limited by this disclosure and may include any carbohydrates or combination of carbohydrates, particularly those used in animal feed and dietary compositions. In some embodiments, the carbohydrate may generally provide a source of energy for the mineral lick composition. Illustrative examples of carbohydrates may include molasses, sugar beet pulp, sugarcane, wheat bran, oat hulls, grain hulls, soybean hulls, peanut hulls, wood, brewery byproducts, beverage industry byproducts, forages, roughages, silages, molasses, sugars, starches, cellulose, hemicellulose, wheat, corn, oats, sorghum, millet, barley, barley fiber, barley hulls, barley middlings, barley bran, malting barley screenings, malting parley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like.

In various embodiments, the glucogenic precursor may include at least one of glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, and/or the like. The glucogenic precursor may generally be included in the feed ingredient to provide an energy source to the ruminant so as to prevent gluconeogenesis from occurring within the ruminant's body.

The antioxidant is not limited by this disclosure and may include any antioxidants or combination of antioxidants, particularly those used in animal feed and dietary compositions. Illustrative examples of antioxidants may include alpha-carotene. beta-carotene, ethoxyquin, butylated hydroxyanisole (BHA), butylated hydroxytoluene (BHT), cryptoxanthin, lutein, lycopene, zeaxanthin, vitamin A, vitamin C, vitamin E, selenium, alpha-lipoic acid, and/or the like.

In various embodiments, the vitamin may include any combination of vitamins including, without limitation, vitamin A, vitamin B, vitamin C, vitamin D, vitamin E, vitamin K, and/or the like. Specific examples of vitamin B include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ).

In some embodiments, the feed ingredient may include an amount of carnitine. The carnitine may be included in the feed ingredient to aid in the breakdown of fatty acids to generate metabolic energy in the ruminant. In some embodiments, the carnitine may be present in a premix composition.

In some embodiments, the amino acid may be an essential amino acid, including any combination of leucine, lysine, histidine, valine, arginine, threonine, isoleucine, phenylalanine, methionine, tryptophan, and/or any derivative thereof. In some embodiments, the amino acid may be a non-essential amino acid, including any combination of alanine, asparagine, aspartate, cysteine, glutamate, glutamine, glycine, proline, serine, tyrosine, and/or any derivative thereof. The amino acid and/or any derivative thereof may also include amino acids and derivatives of both non-essential and essential amino acids. The amino acid may generally be included in the feed ingredient to provide a nutritional aid in various physiological processes in the ruminant, such as, for example, increasing muscle mass, providing energy, aiding in recovery, and/or the like. In some embodiments, the amino acid may be obtained from a premix composition.

In various embodiments, the mineral may be any mineral that is a generally recognized as safe (GRAS) mineral or a combination of such minerals. The mineral may further be obtained from any mineral source that provides a bioavailable mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative examples of sodium salts include monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative examples of calcium salts include calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include magnesium acetate, magnesium carbonate, magnesium oxide, magnesium sulfate, and/or the like. Illustrative cobalt salts include cobalt acetate, cobalt carbonate, cobalt chloride, cobalt oxide, cobalt sulfate, and/or the like. Illustrative examples of manganese salts include manganese carbonate, manganese chloride, manganese citrate, manganese gluconate, manganese orthophosphate, manganese oxide, manganese phosphate, manganese sulfate, and/or the like. Illustrative examples of potassium salts include potassium acetate, potassium bicarbonate, potassium carbonate, potassium chloride, potassium iodate, potassium iodide, potassium sulfate, and/or the like. Illustrative examples of iron salts include iron ammonium citrate, iron carbonate, iron chloride, iron gluconate, iron oxide, iron phosphate, iron pyrophosphate, iron sulfate, reduced iron, and/or the like. Illustrative examples of zinc salts include zinc acetate, zinc carbonate, zinc chloride, zinc oxide, zinc sulfate, and/or the like.

In some embodiments, the protein used in the feed ingredient may be obtained from a protein source. Illustrative examples of protein sources may include one or more grains and/or oilseed meals. The grain is generally not limited by this disclosure and may be any edible grain, or combination of grains, that is used as a protein source. Illustrative examples of grains include cereal grains such as barley, wheat, spelt wheat, rye, oats, triticale, rice, corn, buck wheat, quinoa, amaranthus, sorghum, and the like. Oilseed meal is generally derived from residue that remains after reserved oil is removed from oilseeds. The oilseed meal may be rich in protein and variable in residual fats and oils. Illustrative examples of oilseed meal includes rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like.

In some embodiments, the feed ingredient may include at least one cellulosic material. The cellulosic material may generally provide a source of fiber for the ruminant to lower cholesterol levels and promote proper digestive function. Illustrative examples of cellulosic materials include wheat bran, wheat middlings, wheat mill run, oat hulls, oat bran, soya hulls, grass meal, hay meal, alfalfa meal, alfalfa, straw, hay, algae, algae meal, microalgae, and/or the like.

In various embodiments, the feed ingredient may include a micronutrient mixture. Micronutrient mixtures are not limited by this disclosure and may generally contain any micronutrient mixture now known or later developed. The micronutrient mixture may include various components, such as at least one vitamin and at least one mineral, as described in greater detail herein. In some embodiments, the micronutrient mixture may be present in a premix composition.

In various embodiments, the fatty acid component may generally include one or more free fatty acids and/or glycolipids. Free fatty acids may generally be unconjugated fatty acids, whereas glycolipids may be fatty acids conjugated with a carbohydrate. In some embodiments, the fatty acid component may be present in the dietary composition in an amount of about 30% by weight to about 80% by weight of the dietary composition. In particular embodiments, the fatty acid component may be present in the dietary composition in an amount of about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values. In some embodiments, the fatty acid component may represent about 30% to about 50%, about 30% to about 90%, about 40% to about 60% by weight of the dietary composition.

In some embodiments, the fatty acid component may have a melting point equal to or greater than about 40° C. In some embodiments, the fatty acid component may have a melting point equal to or less than about 80° C. In some embodiments, the fatty acid component may have a melting point of about 40° C. to about 80° C. In particular embodiments, the fatty acid component may have a melting point of about 40° C., about 45° C., about 50° C., about 55° C., about 60° C., about 65° C., about 70° C., about 75° C., about 80° C., or any value or range between any two of these values. The melting point may generally be selected so that it is a temperature that ensures that the fatty acid is inert in the rumen environment.

In various embodiments, the fatty acid component may include at least one saturated fatty acid. For example, the fatty acid component may include 1, 2, 3, 4, 5, 6, or more different saturated fatty acids. In some embodiments, the saturated fatty acid may be present in the fatty acid component in an amount that results in a ruminant consuming the dietary composition to produce a desired quality and quantity of milk, as described in greater detail herein. Thus, in some embodiments, the saturated fatty acid may be present in an amount of about 90% by weight of the fatty acid component to about 100% by weight of the fatty acid component, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values. The saturated fatty acid is not limited by this disclosure, and may include any number of saturated fatty acids now known or later discovered, including all derivatives thereof. For example, derivatives of a saturated fatty acid may include salts, esters, amides, carbonates, carbamates, imides, anhydrides, alcohols, and/or the like.

As used herein, the term “salt” of the fatty acid may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

The term “fatty acid ester” as used herein means an ester of a fatty acid. For example, the fatty acid ester may be in a form of RCOOR′. R may be any saturated or unsaturated alkyl group including, without limitation, C10, C12, C14, C16, C18, C20, and C24. R′ may be any groups having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

As used herein, a “fatty acid amide” may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

A “fatty acid anhydride” may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An “alcohol” of a fatty acid refers to a fatty acid having straight or branched, saturated, radical groups with 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the saturated fatty acid may include a palmitic acid compound. The palmitic acid compound is not limited by this disclosure, and may include one or more of a conjugated palmitic acid, unconjugated palmitic acid, free palmitic acid, palmitic acid derivatives, and/or the like. Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid carbonates, palmitic acid carbamates, palmitic acid imides, palmitic acid anhydrides, and/or the like. The palmitic acid compound may be present in the fatty acid component in an amount of about 60% by weight of the fatty acid to about 100% by weight of the fatty acid, including about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values. In some embodiments, the fatty acid component may consist essentially of the palmitic acid compound. In other embodiments, the fatty acid component may be entirely composed of the palmitic acid compound.

In some embodiments, the saturated fatty acid may include a stearic acid compound. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, stearic acid anhydrides, and/or the like. Because stearic acid in large amounts may hinder milk production capacity of the mammary gland, the amount of stearic acid may be present in the fatty acid component in an amount of about 30% or less by weight of the fatty acid component. In particular embodiments, the stearic acid compound may include about 30% by weight of the fatty acid component, about 25% by weight of the fatty acid component, about 20% by weight of the fatty acid component, about 15% by weight of the fatty acid component, about 10% by weight of the fatty acid component, about 5% by weight of the fatty acid component, or any value or range between any two of these values.

In some embodiments, the fatty acid component may include an unsaturated fatty acid. The term “unsaturated fatty acid” as used herein refers to any mono- and polyunsaturated fat, and includes unsaturated trans fatty acids. The unsaturated fatty acids must contain at least one alkene bond and may contain two or more alkene groups in any position in the hydrocarbon chain, and the unsaturation may or may not be present as a conjugated system of double bonds. The unsaturated fatty acid is not limited by this disclosure, and may include any number of unsaturated fatty acids now known or later discovered, including all derivatives thereof. For example, derivatives of an unsaturated fatty acid may include salts, esters, amides, anhydrides, alcohols, and/or the like, as previously described herein. In various embodiments, a minimal amount of unsaturated fatty acid in the fatty acid component to affect a desired quality of milk produced by the ruminant consuming the dietary composition may be used, as described in greater detail herein. Thus, in some embodiments, the fatty acid component may be substantially free of unsaturated fatty acids. As used herein with respect to unsaturated fatty acids, the term “substantially free” is understood to mean substantially no amount of unsaturated fatty acids or about 10% or less by weight of unsaturated fatty acids, including trace amounts of unsaturated fatty acids. Accordingly, the unsaturated fatty acid may be present in the fatty acid component in an amount of about 10% or less by weight of the fatty acid component, including about 10% or less by weight, about 5% or less by weight, about 4% or less by weight, about 3% or less by weight, about 2% or less by weight, about 1% or less by weight, about 0.5% or less by weight, about 0% by weight, or any value or range between any two of these values.

In various embodiments, at least a portion of the fatty acid component may be contained. In some embodiments, the fatty acid may be pre-contained prior to adding 110 the fatty acid to the feed ingredient. In other embodiments, the fatty acid may be contained as a result of the various processes 105, 110, 115, 120 described herein. In some embodiments, the fatty acid may generally be contained by at least one supermolecular structure. Supermolecular structures may include vesicular structures such as microemulsions, liposomes (vesicles), micelles, and reverse micelles. The liposomes (vesicles) may contain an aqueous volume that is entirely enclosed by a membrane composed of lipid molecules, such as phospholipids. In some embodiments, the liposomes may have a bilayer membrane. In some embodiments, the liposomes may include at least one surfactant. Examples of surfactants may include polyoxyethylene ethers and esters of fatty acids. The surfactant may have an hydrophilic-lipophilic balance (HLB) value of about 2 to about 12, including about 2, about 3, about 4, about 5, about 6, about 7, about 8, about 9, about 10, about 11, about 12, or any range or value between any two of these values. Micelles and reverse micelles are microscopic vesicles that contain amphipathic constituents but do not contain an aqueous volume that is entirely enclosed by a membrane. In micelles, the hydrophilic part of the amphipathic compound is on the outside (on the surface of the vesicle). In reverse micelles, the hydrophobic part of the amphipathic compound is on the outside. The reverse micelles may thus contain a polar core that can solubilize both water and macromolecules within the inverse micelle. As the volume of the core aqueous pool increases, the aqueous environment begins to match the physical and chemical characteristics of bulk water. The resulting inverse micelle may be referred to as a microemulsion of water in oil.

In some embodiments, at least a portion of the fatty acid may be contained in a core of a micelle or a vesicle. The core may include any number of particles therein in addition to the fatty acid. The core composition may be made of a core material that includes at least one of the protein material, the cellulosic material, the amino acid, and the amino acid derivative, as described in greater detail herein.

In various embodiments, at least a portion of the fatty acid component may be encapsulated. In some embodiments, the fatty acid may be pre-encapsulated prior to adding 110 the fatty acid to the feed ingredient. In other embodiments, the fatty acid may be encapsulated as a result of the various processes 105, 110, 115, 120 described herein. In some embodiments, the fatty acid may generally be encapsulated by a capsule. The capsule may include a capsule shell, which is made up of at least one polysaccharide or protein. Illustrative examples of capsule shells as described herein may include capsule shells including agar, gelatin, starch casein, chitosan, soya bean protein, safflower protein, alginates, gellan gum, carrageenan, xanthan gum, phthalated gelatin, succinated gelatin, cellulosephthalate-acetate, polyvinylacetate, hydroxypropyl methylcellulose, polyvinylacetate-phthalate, polymerisates of acrylic esters, polymerisates of methacrylic esters, and/or mixtures thereof.

In various embodiments, the dietary composition may include an amount of water. The water may be included in an amount that is separate from any amounts of water that may be inherently present in any of the other ingredients described herein. The water may generally be present in the dietary composition in an amount that is about 3% or less by weight, including about 0.5% by weight, about 1% by weight, about 2% by weight, about 3% by weight, or any value or range between any two of these values.

In various embodiments, an emulsifier may be combined with the feed ingredient and the fatty acid component to form an emulsion, as depicted in FIG. 2. The fatty acid may be combined 205 with the emulsifier to provide an emulsion. In some embodiments, the emulsion may include, for example, water, sodium palmitate, and palmitate. The combination 205 may include combining the fatty acid and the emulsifier under pressure. In some embodiments, the pressure may be about 1 atm to about 10 atm. In particular embodiments, the pressure may be about 1 atm, about 2 atm, about 3 atm, about 4 atm, about 5 atm, about 6 atm, about 7 atm, about 8 atm, about 9 atm, about 10 atm, or any value or range between any two of these values. The emulsion may be combined 210 with the feed ingredient, other ingredients may be added 215, and the resulting product may be processed 220 as described in greater detail herein to obtain the final product. In some embodiments, the emulsion may be a paste emulsion that is processed 220 by extruding, as described in greater detail herein. The resulting product may be a plurality of particles, pellets, or granular materials. In some embodiments, the emulsion may be processed 220 by drying the emulsion to provide a plurality of granular materials, as described in greater detail herein.

The emulsifier is not limited by this disclosure, and may generally be any composition that is capable of emulsifying the dietary composition. In some embodiments, the emulsifier may be a nonionic emulsifier. Specific examples of nonionic emulsifiers may include ethoxylated fatty alcohols, ethoxylated alkylphenols, ethoxylated fatty acids, sorbitan derivatives, sucrose esters and derivatives, ethylene oxide-propylene oxide block copolymers, fluorinated alkyl polyoxyethylene ethanols, and/or any combination thereof. Other examples of emulsifiers may include lecithin, natural seed weed, natural seed gums, natural plant exudates, natural fruit extracts, animal skin and bone extracts, bio-synthetic gums, starches, fibers, sucrose esters, Tween, polyglycerol esters, sugar esters, castor oil, and ethoxylated castor oil, an ammonia solution, butoxyethanol, propylene glycol, ethylene glycol, ethylene glycol polymers, polyethylene, methoxypolyethylene glycol, and/or any combination thereof. Examples of natural seed weed may include carrageenan, alginates, agar, agarose, fucellan, and xanthan gum or a combination thereof. Examples of natural seed gums may include guar gum, locust bean gum, tara gum, tamarind gum, and psillium gum. Examples of natural plant exudates are gum Arabic, tragacanth, karaya, and ghatti. Natural fruit extracts are, for example, low and high methoxyl pectins. Animal skin and bone extracts are, for example, gelatin A, gelatin B, and hydrolyzed gelatin. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods. In particular embodiments, gum Arabic, guar gum, xanthan gum, and/or pectin may be used in combination as an emulsion stabilizer. Illustrative examples of bio-synthetic gums may include xanthan, gellan, curdian, and pullulan. Examples of starches may include natural starch, chemically modified starch, physically modified starch, and enzymatically modified starch. Castor oil may be effective as an emulsifier because of its ability to render oil soluble in water.

In various embodiments, the emulsifier may have a hydrophilic-lipophilic balance HLB of about 5 to about 14. In particular embodiments, the HLB of the emulsifier may be about 5, about 6, about 7, about 8, about 9, about 10, about 11, about 12, about 13, about 14, or any value or range between any two of these values.

In various embodiments, the emulsifier may be present in the dietary composition in an amount of about 0.01% by weight to about 2.0% by weight of the dietary composition. In particular embodiments, the emulsifier may be present in the dietary composition in an amount of about 0.01% by weight, about 0.05% by weight, about 0.1% by weight, about 0.2% by weight, about 0.25% by weight, about 0.3% by weight, about 0.5% by weight, about 0.6% by weight, about 0.75% by weight, about 1.0% by weight, about 1.25% by weight, about 1.5% by weight, about 1.75% by weight, about 2.0% by weight, or any value or range between any two of these values.

In various embodiments, a method of increasing milk fat content in ruminants may include providing the dietary composition as described herein to the ruminant for ingestion. In particular embodiments, the dietary composition may be a solid dietary composition, as described in greater detail herein. In some embodiments, the dietary composition may be provided as a supplement or a booster. In some embodiments, the composition may be admixed with feed to be provided to the ruminant. In some embodiments, the dietary composition may be provided to the ruminant in an amount that the ruminant receives at least about 10 grams of fatty acid per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided the dietary composition, and/or the like. In some embodiments, the ruminant may be provided with additional amounts of the dietary composition to make up for portions of the dietary composition that are not consumed by the ruminant such as amounts that are spilled by the ruminant when consuming the dietary composition and/or the like.

In some embodiments, providing the dietary composition to the ruminant for the ruminant to consume may result in an increase in production of milk and/or an increase in fat content of the milk produced. These increases may generally be relative to a similar ruminant that does not receive the dietary composition, an average of similar ruminants not receiving the dietary composition, an average of the milk production quantity and fat content of the same ruminant when not provided the dietary composition, and/or the like. In particular embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of about 10% to about 15%, including about 10%, about 11%, about 12%, about 13%, about 14%, about 15%, or any value or range between any two of these values.

### EXAMPLES

### Example 1

### Making a Solid Composition

A solid dietary composition to be used as a feed supplement for ruminant feed is made using a process of combining a feed ingredient and a fatty acid and grinding it into a granular material that can be sprinkled over the ruminant feed. The fatty acid component is combined in an amount that is about 50% by weight of the liquid dietary composition. The fatty acid component includes about 90% by weight of a palmitic acid composition, about 10% by weight of a stearic acid composition, and no unsaturated trans fatty acids. The liquid dietary composition also includes 50% by weight of a feed ingredient to include additional nutrients not currently present and/or lacking in the ruminant's current feed. The feed ingredient includes molasses, sugar beet pulp, calcium propionate, propane diol, thiamine, riboflavin, niacin, biotin, folic acid, choline vitamin D, vitamin E, carnitine, leucine, lysine, a phenylalanine derivative, sodium acetate, calcium carbonate, iron gluconate, barley, wheat, rice, corn, oat hulls, hay meal, and straw. The various ingredients are ground using a standard commercial grinder so that they have an average particle size of about 4 mm.

### Example 2

### Feeding a Dairy Cow

A dairy cow that has a normal (untreated) average daily production of 30 kg milk is provided with the solid dietary composition described above with respect to Example 1 to increase the milk fat and the quantity of the milk produced.

The dairy cow is given about 350 grams of the solid dietary composition by sprinkling the composition on the ruminant's feed. This amount of solid dietary composition is selected to ensure that the cow consumes at least about 333 grams of the solid dietary composition. This amount corresponds to about 10 grams of free palmitic acid for every kilogram of milk that she produces that day. As a result, she produces 10% more milk than she did previously and the milk that she produces contains 10% more milk fat content than the milk she produced previously.

### Example 3

### Providing to a Large Group of Cows

The solid dietary composition as described above with respect to Example 1 is provided to a large group of cows on a commercial dairy farm to confirm its effectiveness. A group of 200 dairy cows from the commercial dairy farm are selected at random to provide a wide variety of variation in various characteristics, such as breed, weight, age of the cow, and the like. The 200 cows are divided into two groups: a sample cow group and a control cow group. Each day, the sample cow group is fed, ad libitum, a standard TMR feed with the solid dietary composition sprinkled thereon. The control cow group is fed the standard TMR feed given to the sample group of cows ad libitum, but without the solid dietary composition as a booster. The 200 cows are monitored for the amount of feed and/or booster consumed, changes in weight, an amount of milk the cow produces each day, and the composition of the milk produced by the cow each day. Monitoring continues for a period of 30 days. A comparison of the two groups of cows over this period of time shows a statistically significant improvement from the group that consumed the solid booster over the control group that did not receive the solid booster.

### Example 4

### Two-Month Study Confirms Efficacy of Solid Dietary Composition

An experiment is performed where conventional complete feed is replaced with a solid dietary composition according to the present disclosure. The experiment is continued for two months. The solid dietary composition includes the following ingredients and amounts (in percent by total weight of the solid dietary composition).

| | |
|---|---|
| Sugar beet pulp | 15 |
| Barley | 15 |
| Palmitic Acid | 40 |
| Wheat bran | 10 |
| Oat bran | 8 |
| Propylene glycol | 8 |
| Molasses | 1 |
| Sodium bicarbonate | 1 |
| Biotin | 1 |
| Carnitine | 0.4 |
| Methionine | 0.5 |
| Emulsifier (non-ionic) | 0.1 |

The ingredients described above are mixed by placing the water in a container and adding the remaining ingredients substantially simultaneously. The mixture may be stirred to ensure the ingredients are well-blended. Upon feeding the mixture to a cow, the following results are obtained from the milk produced by the cow, where “Reference” refers to milk obtained from a similarly treated cow not fed the solid dietary composition.

| | Reference | Test Feed |
|---|---|---|
| Milk (kg/d) | 29.5 | 32.5 |
| Fat % by weight | 3.98 | 4.43 |

As shown in the expected results above, milk fat concentrations and the amount of milk produced increase significantly.

### Example 5

### Fatty Acid Composition

The following table describes a fatty acid composition that is used to increase the volume of milk produced by a ruminant and the milk fat content of the milk produced by the ruminant.

| Fatty Acid | % of Fatty Acid Component (by weight) |
|---|---|
| Palmitic Acid | ≧90 |
| Stearic Acid | ≦10 |
| Unsaturated Trans-fatty Acid | 0 |
| Free Fatty Acids | Approx. 100 |

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A dietary composition for ruminants, the dietary composition comprising:
a fatty acid component, wherein the fatty acid component comprises at least about 90% saturated fatty acid by weight; and
at least one feed ingredient selected from a protein material, a carbohydrate material, an amino acid, an amino acid derivative, a vitamin, a trace element, a mineral, a glucogenic precursor, and an antioxidant,
wherein the fatty acid component is present in the dietary composition in an amount of at least about 30% by weight of the dietary composition, and wherein the dietary composition is a solid in the form of a capsule, a tablet, a pellet, or a granular material.

2. The dietary composition of claim 1, wherein the fatty acid component comprises a palmitic acid compound.

3. The dietary composition of claim 2, wherein the palmitic acid compound comprises free palmitic acid or a palmitic acid derivative selected from a palmitic acid ester, a palmitic acid amide, a palmitic acid salt, a palmitic acid carbonate, a palmitic acid carbamates, a palmitic acid imide, a palmitic acid anhydride, or a combination thereof.

4. The dietary composition of claim 1, wherein the fatty acid component comprises a palmitic acid compound in an amount of at least about 60% by weight of the fatty acid component.

5. The dietary composition of claim 1, wherein the fatty acid component comprises a palmitic acid compound in an amount of at least about 80% by weight of the fatty acid component.

6. The dietary composition of claim 1, wherein the fatty acid component comprises a palmitic acid compound in an amount of at least about 90% by weight of the fatty acid component.

7. The dietary composition of claim 1, wherein the fatty acid component comprises an unsaturated trans fatty acid content in an amount of about 5% or less by weight of the fatty acid component.

8. The dietary composition of claim 1, wherein the fatty acid component comprises an unsaturated trans fatty acid content in an amount of about 4% or less by weight of the fatty acid component.

9. The dietary composition of claim 1, wherein the fatty acid component comprises an unsaturated trans fatty acid content in an amount of about 3% or less by weight of the fatty acid component.

10. The dietary composition of claim 1, wherein the fatty acid component comprises an unsaturated trans fatty acid content in an amount of about 2% or less by weight of the fatty acid component.

11. The dietary composition of claim 1, wherein the fatty acid component comprises an unsaturated trans fatty acid content in an amount of about 1% or less by weight of the fatty acid component.

12. The dietary composition of claim 1, wherein the fatty acid component comprises an unsaturated trans fatty acid content in an amount of about 0.5% or less by weight of the fatty acid component.

13. The dietary composition of claim 1, wherein the fatty acid component is substantially free of unsaturated trans fatty acids.

14. The dietary composition of claim 1, wherein the saturated fatty acid is present in the fatty acid component in an amount of at least about 95% by weight of the fatty acid component.

15. The dietary composition of claim 1, wherein the saturated fatty acid is present in the fatty acid component in an amount of at least about 98% by weight of the fatty acid component.

16. The dietary composition of claim 1, wherein the fatty acid component has a melting point of about 60° C. to about 80° C.

17. The dietary composition of claim 1, wherein the fatty acid component has a melting point equal to or greater than about 40° C.

18. The dietary composition of claim 1, wherein the fatty acid component comprises about 30% or less of a stearic acid compound by weight of the fatty acid component.

19. The dietary composition of claim 1, wherein the fatty acid component is present in the dietary composition in an amount of at least about 50% by weight of the dietary composition.

20. The dietary composition of claim 1, further comprising at least one emulsifier, wherein the emulsifier is capable of emulsifying the dietary composition.

21. The dietary composition of claim 20, wherein the emulsifier is a nonionic emulsifier.

22. The dietary composition of claim 20, wherein the emulsifier has a hydrophilic-lipophilic balance value of about 5 to about 14.

23. The dietary composition of claim 20, wherein the emulsifier comprises castor oil, an ammonia solution, butoxyethanol, propylene glycol, ethylene glycol, ethylene glycol polymers, polyethylene, methoxypolyethylene glycol, or any combination thereof.

24. The dietary composition of claim 20, wherein the emulsifier is present in the dietary composition in an amount of about 0.01% by weight to about 1.0% by weight of the dietary composition.

25. The dietary supplement of claim 20, wherein the emulsifier is present in the fatty acid component in an amount of about 0.2% by weight to about 2.0% by weight of the fatty acid component.

26. The dietary composition of claim 1, wherein the glucogenic precursor comprises at least one of glycerol, propylene glycol, molasses, propionate, glycerine, propane diol, or calcium propionate.

27. The dietary composition of claim 1, wherein the vitamin comprises at least one of vitamin A, vitamin D, vitamin B, vitamin K, vitamin C, or vitamin E.

28. The dietary composition of claim 1, wherein the vitamin comprises at least one B vitamin selected from thiamine, riboflavin, niacin, pantothenic acid, pyridoxine, biotin, folic acid, cobalamin, or choline.

29. The dietary composition of claim 1, wherein the feed ingredient further comprises carnitine.

30. The dietary composition of claim 1, wherein the amino acid is leucine, lysine, histidine, valine, arginine, threonine, isoleucine, phenylalanine, methionine, tryptophan, or any derivative thereof.

31. The dietary composition of claim 1, wherein the mineral is an ion of calcium, sodium, magnesium, potassium, phosphorus, zinc, selenium, manganese, iron, cobalt, copper, iodine, molybdenum, or a combination thereof.

32. The dietary composition of claim 1, wherein the mineral comprises at least one sodium salt selected from monosodium phosphate, sodium acetate, sodium chloride, sodium bicarbonate, disodium phosphate, sodium iodate, sodium iodide, sodium tripolyphosphate, sodium sulfate, or sodium selenite.

33. The dietary composition of claim 1, wherein the mineral comprises at least one calcium salt selected from calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, or tricalcium phosphate.

34. The dietary composition of claim 1, wherein the mineral comprises at least one magnesium salt selected from magnesium acetate, magnesium carbonate, magnesium oxide, or magnesium sulfate.

35. The dietary composition of claim 1, wherein the mineral comprises at least one cobalt salt selected from cobalt acetate, cobalt carbonate, cobalt chloride, cobalt oxide, or cobalt sulfate.

36. The dietary composition of claim 1, wherein the mineral comprises at least one manganese salt selected from manganese carbonate, manganese chloride, manganese citrate, manganese gluconate, manganese orthophosphate, manganese oxide, manganese phosphate, or manganese sulfate.

37. The dietary composition of claim 1, wherein the mineral comprises at least one potassium salt selected from potassium acetate, potassium bicarbonate, potassium carbonate, potassium chloride, potassium iodate, potassium iodide, or potassium sulfate.

38. The dietary composition of claim 1, wherein the mineral comprises at least one iron salt selected from iron ammonium citrate, iron carbonate, iron chloride, iron gluconate, iron oxide, iron phosphate, iron pyrophosphate, iron sulfate, or reduced iron.

39. The dietary composition of claim 1, wherein the mineral comprises at least one zinc salt selected from zinc acetate, zinc carbonate, zinc chloride, zinc oxide, or zinc sulfate.

40. The dietary composition of claim 1, wherein the mineral comprises at least one of copper sulfate, copper oxide, selenium yeast, or a chelated mineral.

41. The dietary composition of claim 1, wherein the protein material comprises at least one of a grain or an oilseed meal.

42. The dietary composition of claim 41, wherein the oilseed meal is selected from at least one of rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, or wheat gluten.

43. The dietary composition of claim 1, wherein the feed ingredient further comprises at least one cellulosic material.

44. The dietary composition of claim 43, wherein the cellulosic material is selected from wheat bran, wheat middlings, wheat mill run, oat hulls, soya hulls, grass meal, hay meal, alfalfa meal, alfalfa, straw, algae, or hay.

45. The dietary composition of claim 1, wherein at least a portion of the fatty acid component is encapsulated by a capsule.

46. The dietary composition of claim 45, wherein the capsule comprises a capsule shell comprising a polysaccharide, a protein, or a combination thereof.

47. The dietary composition of claim 1, wherein at least a portion of the fatty acid component is contained by a plurality of micelles.

48. The dietary composition of claim 1, wherein at least a portion of the fatty acid component is contained by a plurality of vesicles, each of the plurality of vesicles comprising a bilayer membrane.

49. The dietary composition of claim 48, wherein the bilayer membrane comprises at least one surfactant and a palmitic acid compound, wherein the surfactant has a hydrophilic-lipophilic balance value of about 2 to about 12.

50. The dietary composition of claim 49, wherein the at least one surfactant is lecithin.

51. The dietary composition of claim 1, wherein the granular material has an average particle size of about 0.1 mm to about 8 mm.

52. The dietary composition of claim 1, further comprising at least one of a binding agent, a bulking agent, or a filler.

53. The dietary composition of claim 52, wherein the binding agent is selected from at least one of a polysaccharide or a protein.

54. The dietary composition of claim 52, wherein the bulking agent is selected from one or more of silicate, kaolin, or clay.

55. The dietary composition of claim 52, wherein the filler selected from one or more of gluten feed, sunflower hulls, distillers grains, guar hulls, wheat middlings, rice hulls, rice bran, oilseed meals, dried blood meal, animal byproduct meal, fish byproduct meal, dried fish solubles, feather meal, poultry byproducts, meat meal, bone meal, dried whey, soy protein concentrate, soy flour, yeast, wheat, oats, grain sorghum, corn feed meal, rye, corn, barley, aspirated grain fractions, brewers dried grains, corn flower, corn gluten meal, feeding oat meal, sorghum grain flour, wheat mill run, wheat red dog, hominy feed, wheat flower, wheat bran, wheat germ meal, oat groats, rye middlings, cotyledon fiber, algae meal, or ground grains.

56. The dietary composition of claim 1, further comprising an amount of water that is present in the dietary composition in an amount of about 3% or less by weight of the dietary composition.

57. A method of preparing a dietary composition for ruminants, the method comprising:
combining a fatty acid component and a feed ingredient to form a mixture; and
processing the mixture into a tablet, a capsule, a pellet, or a granular material,
wherein the feed ingredient comprises one or more of a protein material, a carbohydrate material, an amino acid, an amino acid derivative, a vitamin, a trace element, a mineral, a glucogenic precursor, and an antioxidant, and wherein the fatty acid component is present in the dietary composition in an amount of at least about 30% by weight of the dietary composition.

58. The method of claim 57, wherein processing comprises at least one of pressing, extruding, grinding, or pelleting the mixture into the tablet, the capsule, the pellet, or the granular material.

59. The method of claim 58, wherein the granular material has an average particle size of about 0.1 mm to about 8 mm.

60. The method of claim 57, further comprising drying the mixture.

61. The method of claim 57, wherein combining the fatty acid component and the feed ingredient comprises:
combining the fatty acid component with water and an emulsifier to form a plurality of micelles or vesicles; and
combining the plurality of micelles or vesicles with the feed ingredient to form the mixture.

62. The method of claim 61, wherein combining the fatty acid component with the water and the emulsifier comprises forming an emulsion comprising water, sodium palmitate, and palmitate.

63. The method of claim 62, wherein the emulsion is a paste emulsion.

64. The method of claim 63, further comprising extruding the paste emulsion to form a plurality of particles, pellets, or granular materials.

65. The method of claim 64, further comprising drying the emulsion to provide a plurality of granular materials.

66. The method of claim 57, wherein the fatty acid component comprises saturated fatty acid in an amount of at least about 90% by weight of the fatty acid component.

67. The method of claim 57, wherein the fatty acid component comprises saturated fatty acid in an amount of at least about 95% by weight of the fatty acid component.

68. The method of claim 57, wherein the fatty acid component comprises saturated fatty acid in an amount of at least about 98% by weight of the fatty acid component.

69. The method of claim 57, wherein the fatty acid component comprises a glucogenic precursor comprising at least one of glycerol, propylene glycol, molasses, propionate, glycerine, propane diol, or calcium propionate.

70. The method of claim 57, wherein the vitamin comprises at least one B vitamin selected from thiamine, riboflavin, niacin, pantothenic acid, pyridoxine, biotin, folic acid, cobalamin, or choline.

71. The method of claim 57, wherein the vitamin is vitamin A, vitamin D, vitamin E, or a combination thereof.

72. The method of claim 57, wherein the amino acid is leucine, lysine, histidine, valine, arginine, threonine, isoleucine, phenylalanine, methionine, tryptophan, any derivative thereof, or a combination thereof.

73. The method of claim 57, wherein the mineral is calcium, sodium, magnesium, potassium, phosphorus, zinc, selenium, manganese, iron, cobalt, copper, iodine, molybdenum, or a combination thereof.

74. The method of claim 57, wherein the protein material is selected from at least one of a grain and an oilseed meal.

75. The method of claim 57, further comprising combining a cellulosic material with the fatty acid component and the feed ingredient to form the mixture.

76. A method of increasing milk fat content in ruminants, the method comprising:
providing a dietary composition to a ruminant for ingestion, wherein the dietary supplement comprises:
a fatty acid component, wherein the fatty acid component comprises less than about 10% unsaturated fatty acid by weight; and
at least one feed ingredient selected from a protein material, an amino acid composition, an amino acid derivative, a vitamin composition, a trace element, a mineral composition, a glucogenic precursor, and an antioxidant,
wherein the fatty acid component is present in the dietary composition in an amount of at least about 30% by weight of the dietary composition, and wherein the dietary composition is a capsule, a tablet, a pellet, or a granular material.

77. The method of claim 76, wherein providing the dietary composition to the ruminant comprises providing the dietary composition to the ruminant at an amount such that the ruminant receives at least about 10 grams of fatty acid per kilogram of milk produced by the ruminant per day.

78. The method of claim 76, wherein providing the dietary supplement to the ruminant results in at least one of an increase in production of milk by the ruminant or an increase in a fat content in the milk produced by the ruminant, relative to a similar ruminant not provided the dietary composition.

79. The method of claim 77, wherein providing the dietary supplement to the ruminant results in at least one of: an at least about 1% increase in production of milk by the ruminant or an at least 10% increase in a fat content in the milk produced by the ruminant, relative to a similar ruminant not provided the dietary composition.

80. A dietary composition for ruminants, the dietary composition comprising:
a fatty acid component comprising a palmitic acid compound in an amount of at least about 90% by weight of the fatty acid component; and
at least one feed ingredient selected from a protein material, an amino acid, an amino acid derivative, a vitamin, a trace element, a mineral, a glucogenic precursor, and an antioxidant,
wherein the fatty acid component is present in the dietary composition in an amount of at least about 30% by weight of the dietary composition, and wherein the dietary composition is a capsule, a tablet, a pellet, or a granular material.

81. The dietary composition of claim 80, wherein the fatty acid component consists essentially of a palmitic acid compound.

82. The dietary composition of claim 80, wherein the fatty acid component consists of a palmitic acid compound.
